(19) United States
(12) Patent Application Publication
(10) Pub. No.: US 2006/0191250 A1
(43) Pub. Date: Aug. 31, 2006

(54) Agricultural mower

(75) Inventors: Horst Neuerburg, Saverne (FR); Johnny Frumholtz, Bourron Marlotte (FR); Renel Walter, Goetzenbruck (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: Kuhn S.A., Saverne Cedex (FR)

(21) Appl. No.: 10/552,899

(22) PCT Filed: Apr. 6, 2004
(86) PCT No.: PCT/FR04/00856

§ 371 Date: Oct. 11, 2005

(30) Foreign Application Priority Data
Apr. 11, 2003 (FR) 03/04550

(51) Int. Cl. A01D 75/30

(52) U.S. Cl. 56/6

(57) ABSTRACT

An agricultural mower including at least one working unit configured to cut a standing product and a connecting device configured to connect the at least one working unit to a motor vehicle. During work the connecting device allows the at least one working unit to move transversely with respect to a direction of forward travel of the mower. The mower further includes an operating member configured to cause the transverse movement of the at least one working unit and a control device configured to measure the roll angle of the mower, and to control the operating member, so as to keep a cutting overlap at an optimum value.

The present invention relates to the overall technical field of agricultural machinery. It relates more specifically to an agricultural mower comprising:
at least one working unit intended to cut a standing product,
a connecting device intended to connect the at least one working unit to a motor vehicle; during work, the connecting device allows the at least one working unit to move transversely with respect to a direction of forward travel of the mower, and
an operating member intended to cause the transverse movement of the at least one working unit.

Such an agricultural mower is known to those skilled in the art, particularly from FR-A-2 717 343. This earlier document describes an agricultural implement consisting of a motor vehicle and of three working units intended to cut a standing product, such as grass for example. This agricultural implement more specifically comprises a frontal working unit and two lateral working units. The frontal working unit is positioned in front of the motor vehicle. The lateral working units are, for their part, positioned one on each side of a longitudinal axis of the motor vehicle and behind the frontal working unit.

Each lateral working unit is connected to the motor vehicle by means of articulations. During work, these articulations advantageously allow the lateral working units to follow the unevennesses of the ground. Specifically, the lateral working units can thus move in a vertical direction independently of the position of the motor vehicle. During transport, these articulations allow the lateral working units to be raised up by pivoting them through 90°.

For its part, the frontal working unit is connected to the motor vehicle by means of a lift device. This lift device also allows the frontal working unit a relative movement in a substantially vertical direction with respect to the motor vehicle. During work, this relative movement advantageously allows the frontal unit to follow the unevennesses of the ground. This substantially vertical relative movement is also used in order to obtain a transport position.

Advantageously, the layout of these three working units is such that the working area of each lateral unit slightly overlaps the already-worked area of the frontal unit. This overlap, termed a cutting overlap, of the individual working area constitutes a margin of safety that one sets in order to guarantee that the product is perfectly cut over the entire working area of the agricultural implement.

Now, when such an agricultural implement is following a curved path, the amount of cutting overlap between the frontal working unit and the lateral working unit lying on the inside of the bend naturally tends to decrease. In order nevertheless to maintain a minimum amount of cutting overlap in spite of this phenomenon, the frontal working unit described in that earlier document may advantageously be moved transversely with respect to a direction of forward travel of the motor vehicle. To achieve that, the lift device additionally comprises link rods defining a deformable parallelogram in a horizontal plane. The deformation of this parallelogram is brought about by means of a ram. In addition, in that earlier document, the ram is supplied with pressurized fluid according to the orientation of the steering wheel of the motor vehicle. Thus, the transverse position of the frontal working unit is automatically corrected in curved paths.

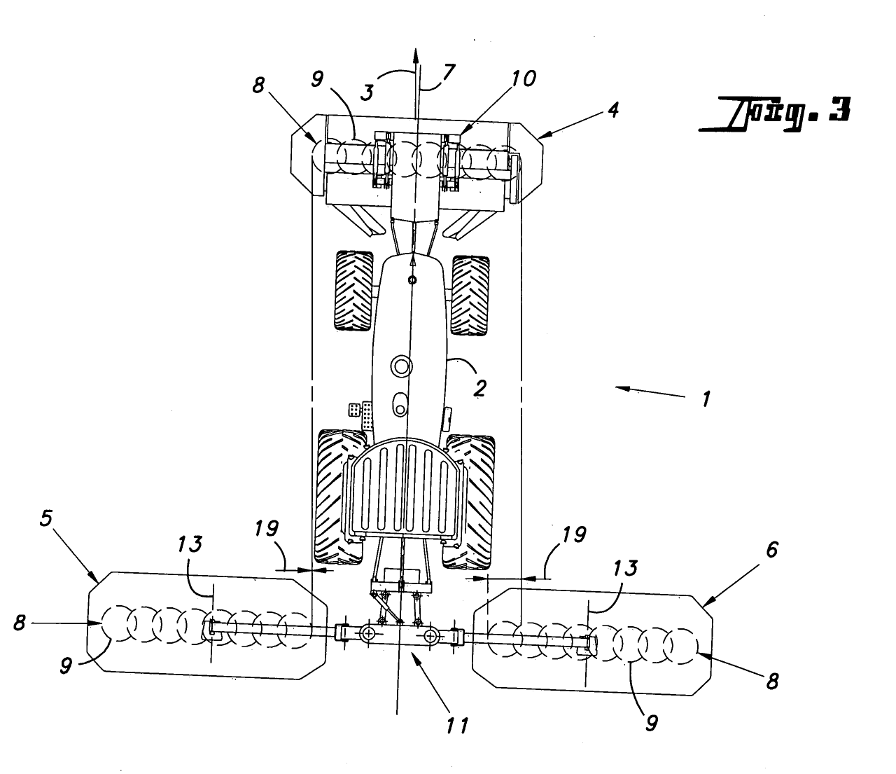

However, it has become apparent that when an agricultural implement such as this is working on sloping land, the amount of cutting overlap between the working units tends to decrease even in straight paths. By moving transversely with respect to a slope, any vehicle in fact tends to crab somewhat, that is to say that the longitudinal axis of the vehicle becomes somewhat inclined with respect to the direction of forward travel. In the light of FIG. 3, this inclination causes an offset between the cutting area of the lateral working units and the cutting area of the frontal working unit, hence changing the cutting overlap. In the case of agricultural implements in which the distance between the lateral working units and the frontal working unit is relatively large, the magnitude of this offset may reach or even exceed the amount of cutting overlap. In such an instance, the agricultural implement will leave behind it strips of uncut product. The presence of strips of uncut product entails an additional pass by the agricultural implement, hence losing time for the user.

This variation in the cutting overlap during work on a slope is also encountered when the motor vehicle is connected to just one mower, whether this be of the mounted type or of the trailed type. Depending on the direction of the slope, the crab of the carrier vehicle and/or of the trailed mower tends also to increase or decrease the amount of cutting overlap between the area worked by this pass and the area worked during the previous pass. As described earlier, an excessive reduction in the cutting overlap may lead to the appearance of strips of uncut product. Likewise, an excessive increase in the cutting overlap is also a disadvantage because the working width of the mower will be used only partially, hence reducing efficiency.

The object of the present invention is to guarantee, automatically, an optimum cutting overlap in an agricultural mower when working on a slope.

To this end, the mower according to the present invention is characterized in that it additionally comprises a control device intended to control the operating member according to the roll angle of the agricultural mower, so as to keep a cutting overlap at an optimum value.

Thus, the transverse position of the working unit with respect to the motor vehicle is modified automatically according to the slope of the land. This transverse movement of the working unit makes it possible to compensate for any crabbing and therefore guarantee an optimum amount of cutting overlap.

Other features of the invention, to be considered separately or in all possible combinations, will become further apparent from the following description of some nonlimiting exemplary embodiments of the invention which are depicted in the appended drawings in which:

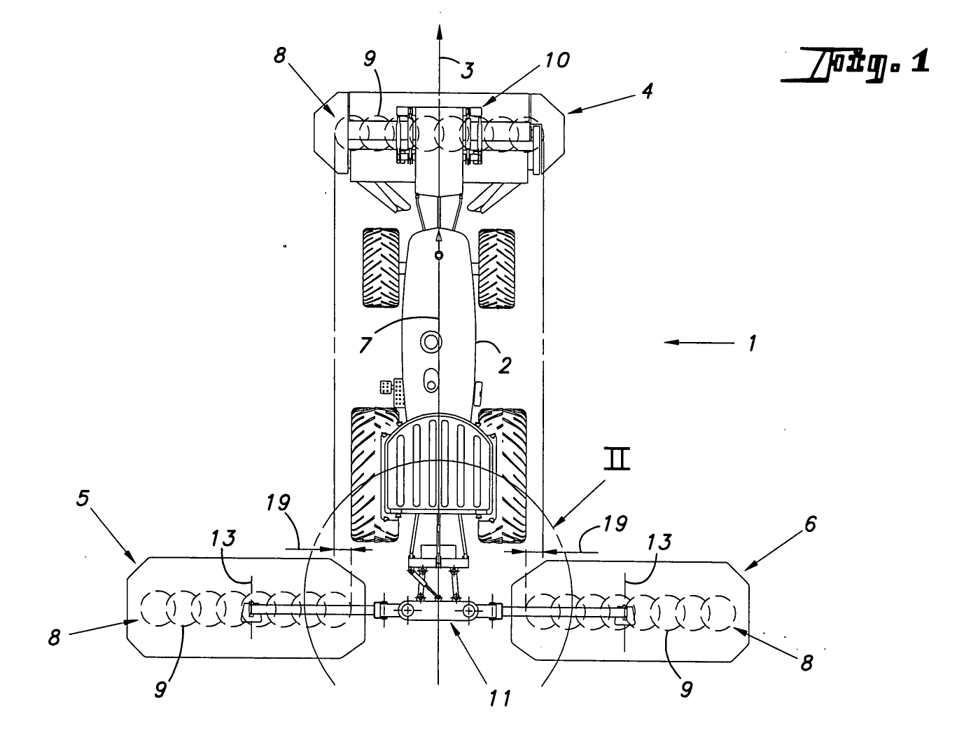

FIG. 1 depicts a view from above of a mower according to the present invention, working on horizontal land,

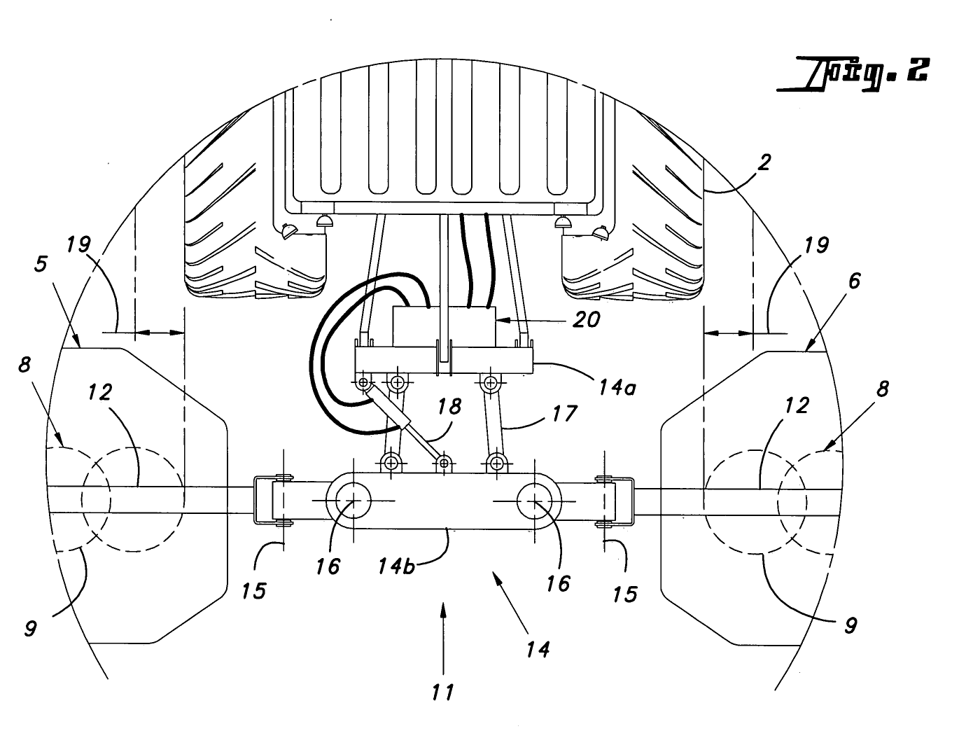

FIG. 2 depicts an enlargement of detail II in FIG. 1,

FIG. 3 depicts the mower of FIG. 1 when working on a slope, the control device not having been activated, so as to represent the state of the art,

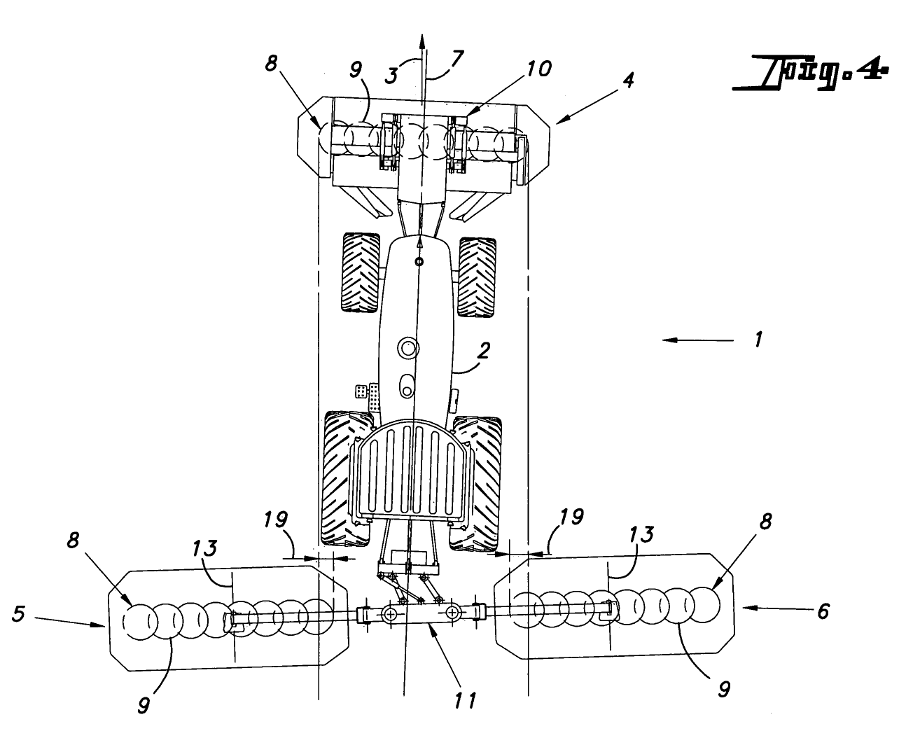

FIG. 4 depicts the mower of FIG. 2 with the control device activated,

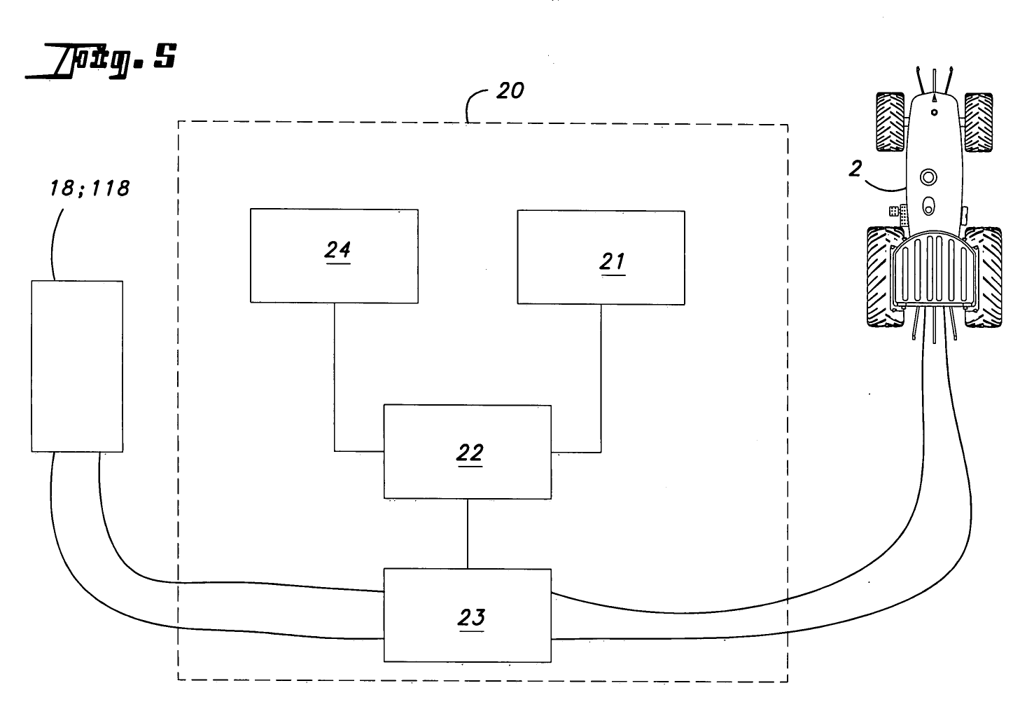

FIG. 5 schematically depicts a control device,

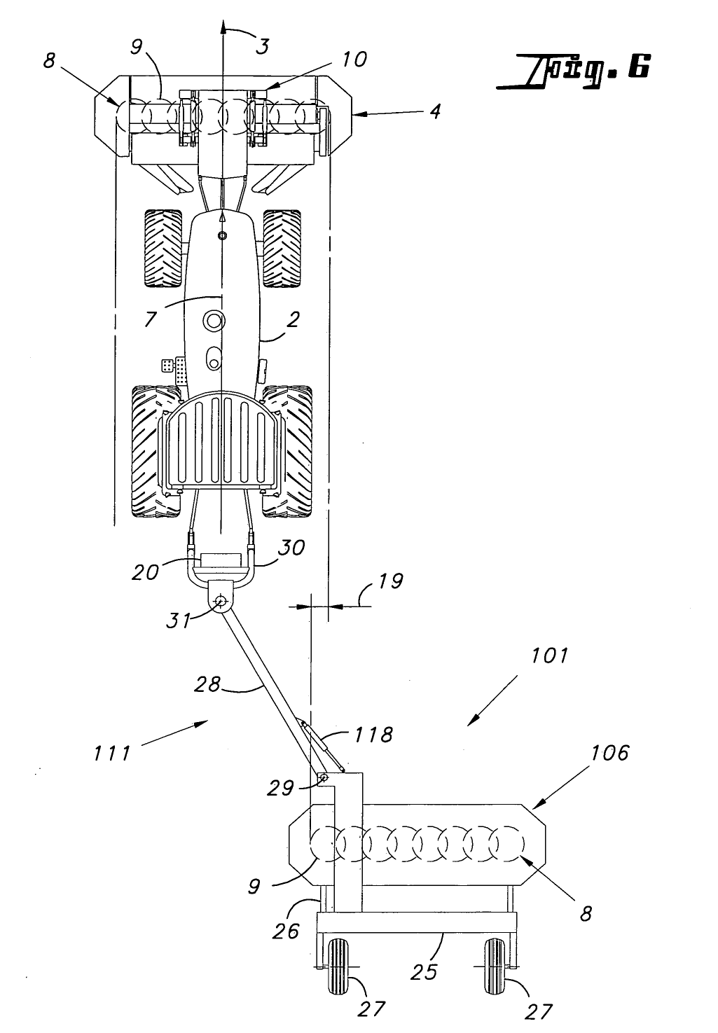

FIG. 6 depicts a view from above of another mower according to the present invention, working on horizontal land,

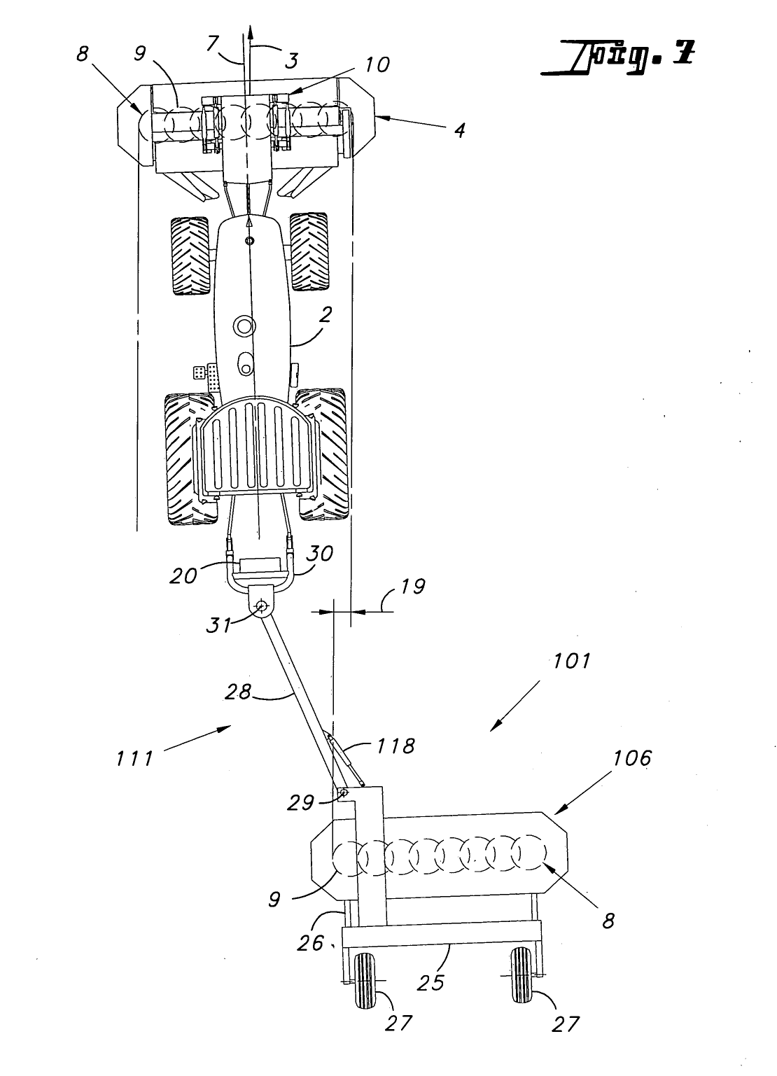

FIG. 7 depicts the mower of FIG. 6 when working on a slope with the control device activated, and

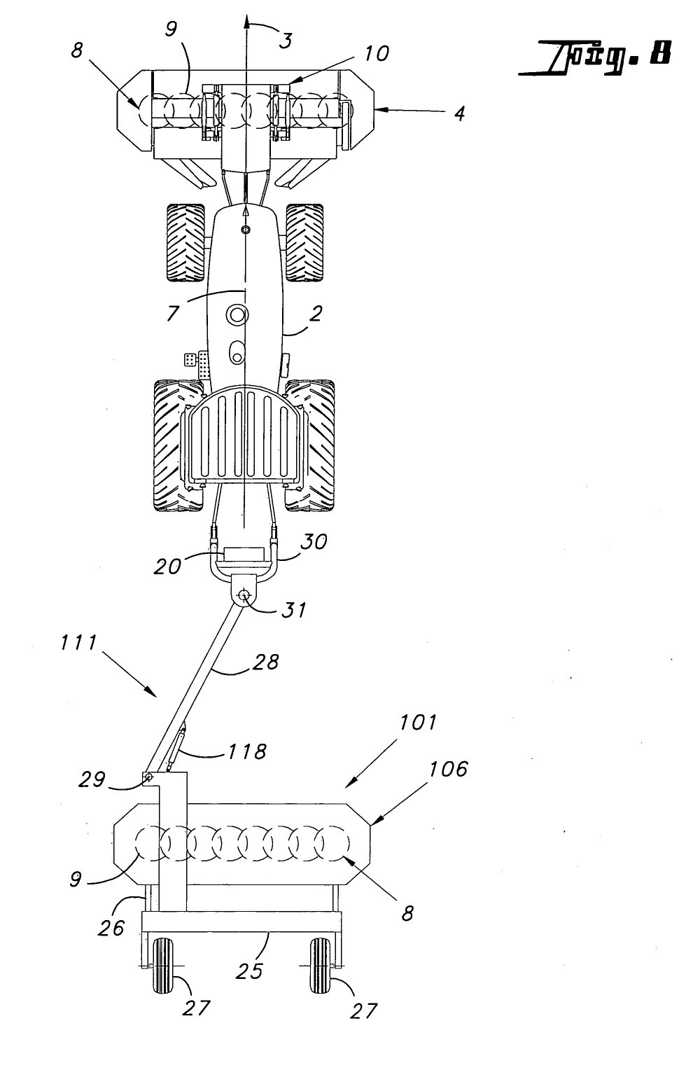

FIG. 8 depicts the mower of FIG. 6 in the transport position.

FIG. 1 depicts a first exemplary embodiment of an agricultural mower (1) according to the present invention. The mower (1) is coupled to a motor vehicle (2) which pulls it in a direction and sense of forward travel indicated by the arrow (3). In the remainder of the description, the ideas of “front” and “rear”, “at the front of” and “at the rear of” are defined with respect to the direction of forward travel (3) and the ideas of “right” and “left” are defined when considering the mower (1) from behind in the direction of forward travel (3).

In this first exemplary embodiment, the mower (1) is a combination of three working units (4, 5, 6). More specifically, the mower (1) comprises a frontal working unit (4) and two lateral working units (5, 6). In the light of FIG. 1 in particular, the frontal working unit (4) is positioned in front of the motor vehicle (2) and straddling a longitudinal axis (7) thereof. The lateral working units (5, 6) by contrast are positioned one on each side of the longitudinal axis (7) and behind the frontal working unit (4). In order to obtain better distribution of the masses, the lateral working units (5, 6) are advantageously positioned behind the motor vehicle (2).

In a way known to those skilled in the art, each working unit (4, 5, 6) comprises a cutting device (8) intended to cut a standing product such as grass for example. To do this, the cutting device (8) in turn comprises at least one cutting member (9) rotationally driven about an upwardly directed axis. The relatively high rotational speed, approximately 3000 revolutions per minute, of the cutting member (9) allows the latter to cut the standing product by impact. By way of nonlimiting example, the cutting devices (8) depicted in the figures each comprise eight cutting members (9) positioned in a line. Each cutting unit (4, 5, 6) is thus able to cut over a width of about three meters. In a way also known to those skilled in the art, each cutting unit (4, 5, 6) may additionally comprise a conditioning device intended to accelerate the drying-out of the cut product and/or a setting-down device intended to size the windrow formed by the product once cut. Such conditioning and setting-down devices have not been depicted in the figures. Likewise, since the transmission elements intended to drive the working units (4, 5, 6) off the power take-offs of the motor vehicle (2) are widely known to those skilled in the art, these transmission elements have not been depicted in the figures.

In this first exemplary embodiment, the mower (1) comprises a first connecting device (10) intended to connect the frontal working unit (4) to the motor vehicle (2). As a preference, the first connecting device (10) allows the frontal working unit (4) during work to follow the unevennesses of the ground independently of the position of the motor vehicle (2). To do that, the first connecting device (10) allows both a substantially vertical translational movement and a rolling movement between the frontal working unit (4) and the motor vehicle (2). Also as a preference, the first connecting device (10) allows at least some of the weight of the frontal working unit (4) to be transferred during work onto the motor vehicle (2). By thus reducing the ground pressure exerted by the frontal working unit (4), the traction needed to move the agricultural mower (1) along is particularly reduced. In order to perform these various functions, the first connecting device (10) comprises, by way of example, a system of link rods and springs. Since these various means or their technical equivalents and their layout are known to those skilled in the art, the first connecting device (10) will not be described further.

In this first exemplary embodiment, the mower (1) also comprises a second connecting device (11) intended to connect the lateral working units (5, 6) to the motor vehicle (2). In the light of FIGS. 1 and 2 in particular, each lateral working unit (5, 6) is connected to one end of a respective support arm (12) by means of a first articulation (13) the axis of which is directed in the direction of forward travel (3). The other end of the support arm (12) is connected to a chassis (14) by means of a second articulation (15) the axis of which is also directed in the direction of forward travel (3) and by means of a third articulation (16) of upwardly directed axis. For its part, the chassis (14) is connected to the motor vehicle (2).

As a preference, the axis of the second articulation (15) and the axis of the third articulation (16) are concurrent. Likewise, the axis of the first articulation (13) and the axis of the second articulation (15) are advantageously parallel. Thus, the first and second articulations (13, 15) allow the corresponding lateral working unit (5, 6) to follow the unevennesses of the land independently of the position of the motor vehicle (2). The third articulation (16) for its part allows the corresponding lateral working unit (5, 6) to shift backwards should it encounter an obstacle.

In a way known to those skilled in the art, the second connecting device (11) additionally comprises means for transferring at least some of the weight of the lateral working units (5, 6) onto the chassis (14) and therefore onto the motor vehicle (2). Drive members are also provided for causing the lateral working units (5, 6) to pivot about the second articulation (15) from a substantially horizontal working position into a substantially vertical transport position and vice versa. As these various elements are widely known, they will not be described further.

In this first exemplary embodiment, the second connecting device (11) allows the lateral working units (5, 6) to move transversely during work with respect to a longitudinal axis (7) of the motor vehicle (2). To do that, and in the light of FIG. 2, the chassis (14) comprises a front part (14a) connected to the motor vehicle (2) and a rear part (14b) connected to the support arms (12). The chassis (14) additionally comprises two link rods (17) the ends of which are connected, on the one hand, to the front part (14a) and, on the other hand, to the rear part (14b) by means of articulations of upwardly directed axis. The two link rods (17) thus form a deformable quadrilateral allowing the rear part (14b) to move relative to the front part (14) in a transverse direction. In order to deform the quadrilateral thus created, an operating member (18) is provided. In the example depicted in FIG. 2, the operating member (18) is produced by means of a hydraulic ram (18) the ends of which are connected, on the one hand, to the front part (14a) and, on the other hand, to the rear part (14b) by means of articulations of upwardly directed axis. As a preference, the ram (18) is a double acting ram. The supply of pressurized fluid to the ram (18) is from a pump present on the motor vehicle (2) and by means of pipes.

According to an important feature of the present invention, the agricultural mower (1) additionally comprises a control device (20) intended to control the operating member (18) according to the roll angle of the mower (1).

In the exemplary embodiment depicted schematically in FIG. 5, the control device (20) for this purpose comprises a sensor (21) allowing the angle of inclination of the mower (1) about the longitudinal axis (7) of the motor vehicle (2), that is to say the roll angle, to be measured with respect to the horizontal. By way of nonlimiting example, such a sensor (21) may be produced using an inclinometer. The control device (20) also comprises a driving unit (22) intended to process the information from the sensor (21). The control device (20) additionally comprises a hydraulic distributor (23) arranged on the pipes connecting the ram (18) to the motor vehicle (2). The hydraulic distributor (23) makes it possible, according to the commands given by the driving unit (22), to supply the ram (18) with pressurized fluid, or not supply the ram. Thus, when the motor vehicle (2) is working on sloping land, the control device (20) automatically retracts or extends the rod of the ram (18) so as to move the lateral working units (5, 6) transversely.

As a preference, the control device (20) further comprises a detection means (24) for informing the driving unit (22) when the lateral working units (5, 6) have reached a central position, that is to say when the lateral working units (5, 6) are positioned symmetrically one on each side of the longitudinal axis (7). Thus, the control device (20) is capable of automatically recentering the lateral working units (5, 6) when the motor vehicle (2) is once again moving over horizontal land. In this first exemplary embodiment, such automatic recentering of the lateral working units (5, 6) is also advantageous for placing the mover (1) in the transport position.

By way of example, such a detection means (24) may be produced by a contactor fixed to one of the parts (14a, 14b) of the chassis (14) and feeling the other of the parts (14a, 14b). This contactor then transmits a signal to the driving unit (22) when the lateral working units (5, 6) have reached the central position.

This recentering function may also be achieved by means of a ram comprising two independent rods. In a way known to those skilled in the art, such a ram is capable of defining at least three distinct positions. A retracted position, an intermediate position and a deployed position. With such a ram and an appropriate distributor (23), the control device (20) is capable of recentering the lateral working units (5, 6) without recourse to the detection means (24).

Advantageously, the driving unit (22) determines, for each value of the roll angle, the optimum amount of transverse movement to be imparted to the lateral working units (5, 6). To do that, the detection means (24) is preferably produced as a position sensor constantly informing the driving unit (22) of the relative position of the front part (14a) with respect to the rear part (14b) of the chassis (14). Thus, the driving unit (22) acts appropriately on the distributor (23) as long as the value indicated by the position sensor does not correspond to the determined optimum movement.

By way of example, the optimum movement may be defined as being a continuous function of the roll angle. In another exemplary embodiment, the optimum transverse movement may be defined discontinuously. Thus, for various thresholds that the roll angle reaches, a specific value is assigned as being the optimum movement. It is also possible to use a combination of these two ways of determining the optimum movement.

The mower (1) according to the present invention works as follows.

On horizontal land, the lateral working units (5, 6) are arranged symmetrically one on each side of the longitudinal axis (7) of the motor vehicle (2). In the light of FIGS. 1 and 2, this positioning is such that the working area of each lateral working unit (5, 6) slightly overlaps the area already worked by the frontal working unit (4). This overlap, known as the cutting overlap (19), of the individual working areas constitutes a safety margin that one sets in order to guarantee perfect cutting of the product over the entire working area of the mower (1). By way of indication, the magnitude of such a cutting overlap is of the order of 250 millimeters.

On sloping land, that is to say when the motor vehicle (2) is moving transversely to a slope as depicted in FIGS. 3 and 4, the motor vehicle (2) has a tendency to slip toward the bottom of the slope. Thus, although it is in a straight path, the longitudinal axis (7) of the motor vehicle (2) adopts an inclination with respect to the direction of forward travel (3). This results in a reduction in the cutting overlap (19) between the frontal working unit (4) and one of the lateral working units (5, 6). In the light of FIG. 3 which represents the state of the art, it may thus happen that the value of the cutting overlap (19) drops below a minimum threshold and even becomes zero. In such instances and in a way that the user finds unacceptable, the agricultural mower (1) would leave strips of uncut product behind it. To avoid that, in the light of FIG. 4 and according to the present invention, the control device (20) commands the operating member (18) to move the lateral working units (5, 6) transversely. Thus, in a way that is entirely automatic, the control device (20) is capable of keeping the cutting overlap (19) at an optimum value during work on a slope.

As a preference, and in the light of FIG. 2 in particular, the link rods (17) connecting the front part (14a) and the rear part (14b) of the chassis (14) advantageously form a trapezium converging toward the front. Thus, any transverse movement of the lateral working units (5, 6) is also accompanied by a pivoting about an upwardly directed axis. This combination of translational and pivoting movements advantageously increases the amount by which the cutting overlap (19) varies.

In a way which is also preferred, the sensor (21) additionally allows the yaw angle of the motor vehicle (2) to be measured. The control device (20) is thus capable of determining the radius of curvature of the path taken by the motor vehicle (2) and of correcting the position of the lateral working units (5, 6) accordingly. As a result, the amount of cutting overlap (19) is kept optimum even in a curved path followed on horizontal land. By way of nonlimiting example, such a sensor (21) is produced using an inertia unit.

In the first exemplary embodiment depicted in FIGS. 1 to 4, the mower (1) is a combination of three working units (4, 5, 6). However, the present invention also applies to mowers, not depicted, comprising a frontal working unit (4) and a single lateral working unit (2), both mounted on a motor vehicle (2).

FIGS. 6 to 8 depict, from the same standpoint as FIGS. 1 to 4, a second exemplary embodiment of a mower according to the present invention. This mower (101) has a certain number of elements already described earlier. These elements will therefore retain the same reference numeral and will not be described again. It also comprises a certain number of elements which are comparable with elements of the mower (1) which were described earlier. These elements will be assigned the same reference numeral as these comparable elements of the mower (1), but increased by 100. They will be described only if necessary.

Thus, the mower (101) comprises a frontal working unit (4) arranged at the front of the motor vehicle (2) and straddling a longitudinal axis (7) thereof. The frontal working unit (4) is similar to the one described in the first exemplary embodiment. The mower (101) also comprises a lateral working unit (106). The lateral working unit (106) is connected to the motor vehicle (2) by means of a connecting device (111).

In this second exemplary embodiment, the lateral working unit (106) is of the trailed type. In a known way, the connecting device (111) therefore comprises a chassis (25), a drawbar (28) and a hitching head (30). Thus, in the light of FIGS. 6 to 8, the lateral working unit (106) is connected to the chassis (25) by means of a suspension (26) known to those skilled in the art. The suspension (26) advantageously allows the lateral working unit (106) to follow the unevennesses of the ground independently of the position of the chassis (25). The suspension (26) also allows at least some of the weight of the lateral working unit (106) to be transferred onto the chassis (25). The chassis (25) rests on the ground, during work and during transport, by means of two wheels (27). One of the ends of the drawbar (28) is connected to the chassis (25) by means of an articulation (29) of upwardly directed axis. The other end of the drawbar (28) is connected to the hitching head (30) by means of another articulation (31) also of upwardly directed axis. For its part, the hitching head (30) is intended to be connected to the motor vehicle (2). An operating member (118) for pivoting the drawbar (28) with respect to the chassis (25) about the articulation (29) is also provided. In the light of FIGS. 6 to 8, the operating member (118) is achieved by means of a hydraulic ram (118) the ends of which are connected, on the one hand, to the drawbar (28) and, on the other hand, to the chassis (25) by means of articulations of upwardly directed axis. As a preference, the ram (118) is a double-acting ram. The ram (118) is supplied with pressurized fluid from a pump present on the motor vehicle (2) and by means of pipes.

When the mower (101) is trailed by the motor vehicle (2), the connecting device (111) thus formed allows the lateral working unit (106) to be moved transversely. Specifically, in the light of FIG. 8, the shortening of the ram (118) allows the lateral working unit (16) to be positioned in the continuation of the motor vehicle (2). This position is used in particular for transport on the public highway. By contrast, a lengthening of the ram (118) allows the lateral working unit (106) to be positioned in the work position as depicted in FIGS. 6 and 7.

In a way that is particularly advantageous, the mower (101) also comprise a control device (20) similar to the one described in the first exemplary embodiment. Just as was the case in the first exemplary embodiment, the control device (20) acts automatically on the ram (118) so as to guarantee a minimum cutting overlap (19) when working on a slope in particular.

In this second exemplary embodiment, the detection means (24) this time detects the angular position of the drawbar (28) with respect to the chassis (25) about the articulation (29). This angular position of the drawbar (28) allows the transverse position of the working unit (106) to be determined. The detection means (24) thus allows the control device (20) to reposition the mower (101) in the position of FIG. 6 when the motor vehicle (2) is once again moving over horizontal land.

The agricultural mowers (1; 101) which have just been described are merely exemplary embodiments which must not in any way be taken to limit the field of protection defined by the claims that follow.

Thus, the mower (1; 101) will not necessarily comprise a working unit (4) positioned at the front of the motor vehicle (2). In this case, the cutting overlap (19) is measured from the area cut in the previous pass.

Likewise, the control device (20) could very well not contain the sensor (21) intended to measure the roll angle of the mower (1; 101). Indeed, according to another exemplary embodiment, the information regarding the roll angle of the mower (1; 101) could originate from a sensor already present on the motor vehicle (2).

1-11. (canceled)

12. An agricultural mower comprising:
at least one frontal working unit configured to cut a standing product;
at least one lateral working unit configured to cut a standing product;
connecting devices configured to connect the working units to a motor vehicle, at least one of the connecting devices allowing the corresponding working unit to move transversely during work with respect to a direction of forward travel of the mower;
an operating member configured to cause the transverse movement of the at least one working unit; and
a control device configured to control the operating member;
wherein the control device comprises a sensor configured to measure a roll angle of the mower and a driving unit processing information from the sensor and controlling a distributor configured to act on the operating member so as to move the at least one lateral working unit transversely to keep a cutting overlap at an optimum value.

13. A mower as claimed in claim 12, wherein the connecting device for connecting the at least one lateral working unit comprises a front part configured to be connected to the motor vehicle and a rear part to which the at least one working unit is connected, wherein the front part and the rear part are connected to one another by link rods defining a deformable quadrilateral.

14. A mower as claimed in claim 13, wherein the link rods define a trapezium converging towards the front.

15. A mower as claimed in claim 13, wherein the rear part supports two working units.

16. A mower as claimed in claim 13, wherein the operating member is connected to the front part and to the rear part.

17. A mower as claimed in claim 12, wherein the connecting device for connecting the at least one lateral working unit comprises a chassis resting on the ground by wheels and to which the working unit is connected, a hitching head configured to be connected to the motor vehicle, and a drawbar connected at each of its ends to the chassis and the hitching head by a respective articulation having an axis directed upwards.

18. A mower as claimed in claim 17, wherein the operating member is connected to the chassis and to the drawbar.

19. A mower as claimed in claim 12, wherein the at least one lateral working unit is positioned at the rear of the motor vehicle.

20. A mower as claimed in claim 12, wherein the sensor additionally allows yaw angle of the motor vehicle to be measured.

21. A mower as claimed in claim 12, wherein the control device further comprises a detection means for informing the driving unit when the at least one working unit has reached a central position.

22. A mower as claimed in claim 21, wherein the detection means comprises a position sensor configured to measure the transverse position of the at least one working unit with respect to the motor vehicle.
